(19) United States
(12) Patent Application Publication
(10) Pub. No.: US 2014/0233916 A1
(43) Pub. Date: Aug. 21, 2014

(54) INTEGRATING SELECTED VIDEO FRAMES INTO A SOCIAL FEED

(71) Applicant: TANGOME, INC., Palo Alto, CA (US)

(72) Inventors: Ian Barile, Palo Alto, CA (US); Gregory Dorso, San Jose, CA (US); Gary Chevsky, Palo Alto, CA (US); Yuxin Liu, Cupertino, CA (US); Xu Liu, San Jose, CA (US); Eric Setton, Menlo Park, CA (US); Jamie Odell, Foster City, CA (US)

(73) Assignee: TANGOME, INC., Palo Alto, CA (US)

(21) Appl. No.: 13/770,584

(22) Filed: Feb. 19, 2013

(51) Int. Cl. H04N 9/79

(52) U.S. Cl. CPC H04N 9/79
USPC 386/285; 386/326; 386/278

(57) ABSTRACT

A method for integrating selected video frames into a social feed is described. The method includes: accessing a video stream at a device; detecting a set of features within at least one frame of the video stream to achieve a detected set of features; determining at least one moment comprising a combination of the detected set of features to achieve a determined at least one moment; accessing an integration instruction associated with the determined at least one moment; and integrating a selected moment of the determined at least one moment into a social feed based on the integration instruction.

### BACKGROUND

Video calling services allow individuals to express themselves continuously in a fluid medium. Additionally, the fluidity of this video medium allows for the expression of many different emotions, views, people and events. However, there exist many limitations to capturing and recording video moments during a video conference call.

### DESCRIPTION OF EMBODIMENTS

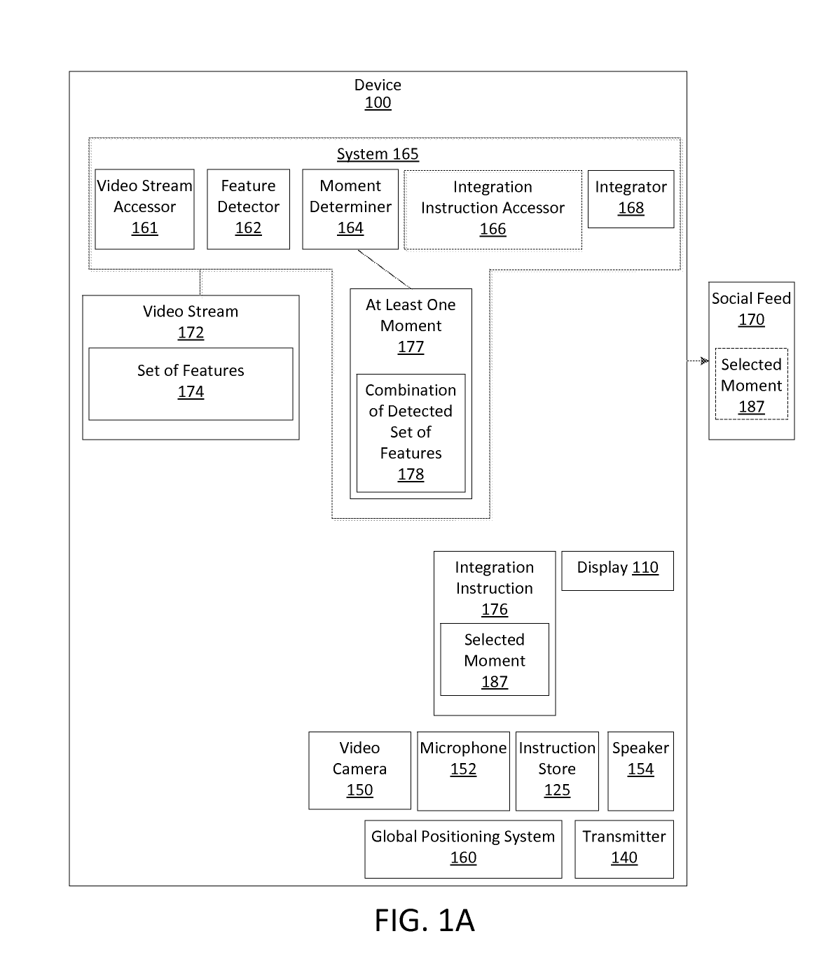

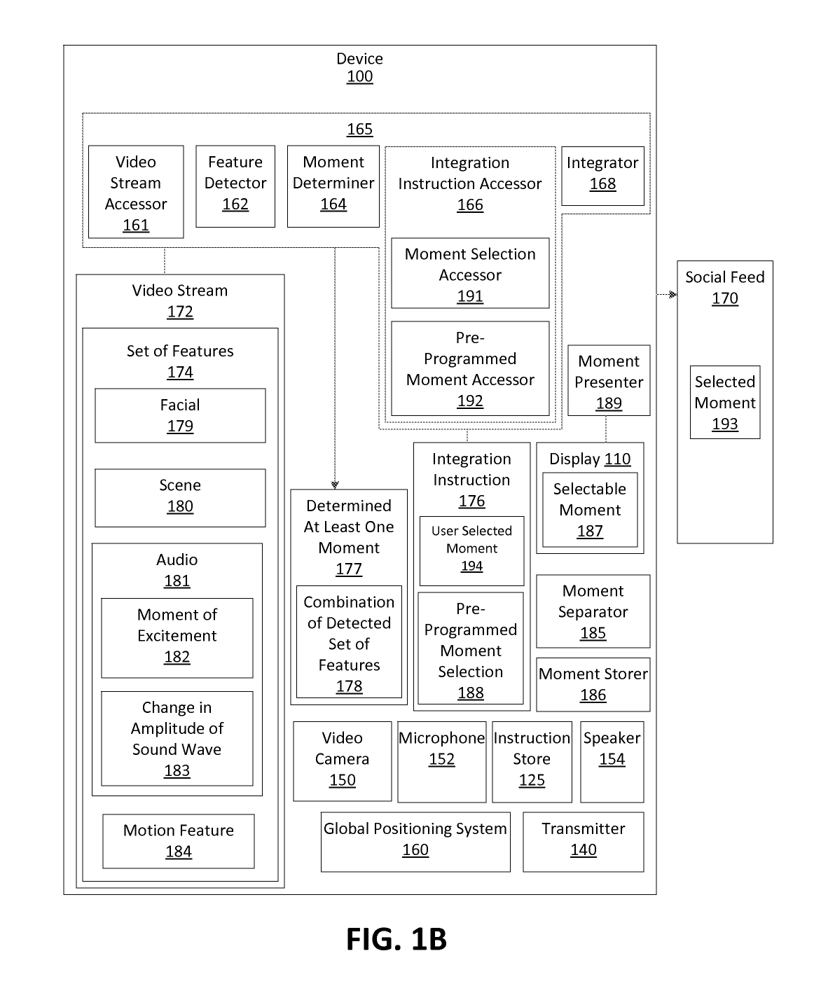

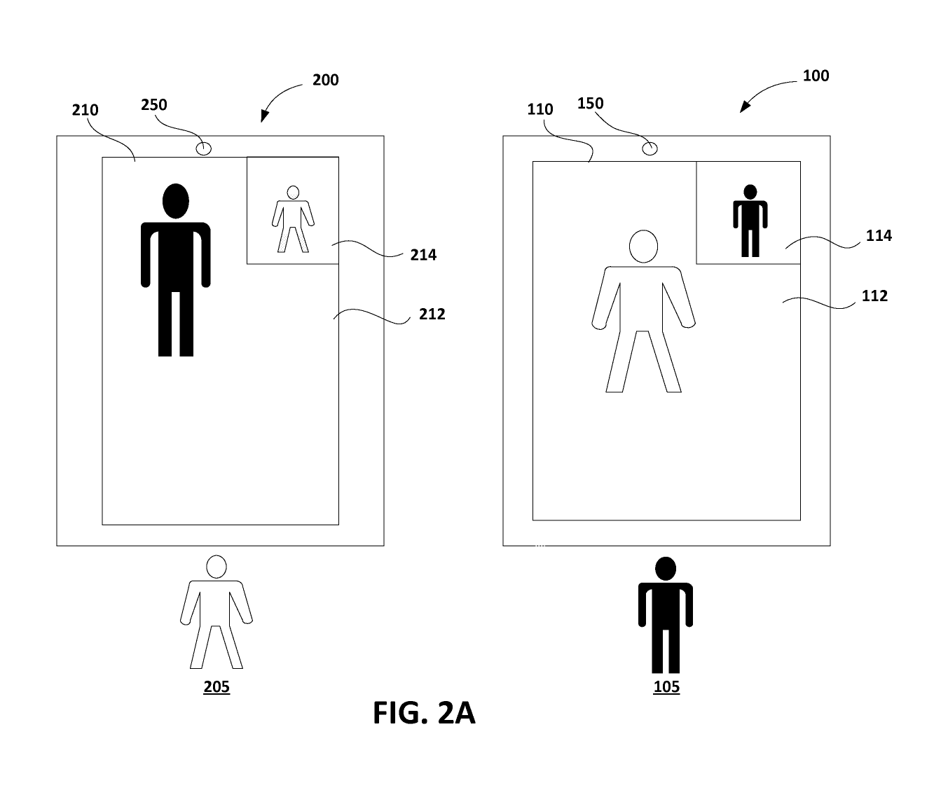

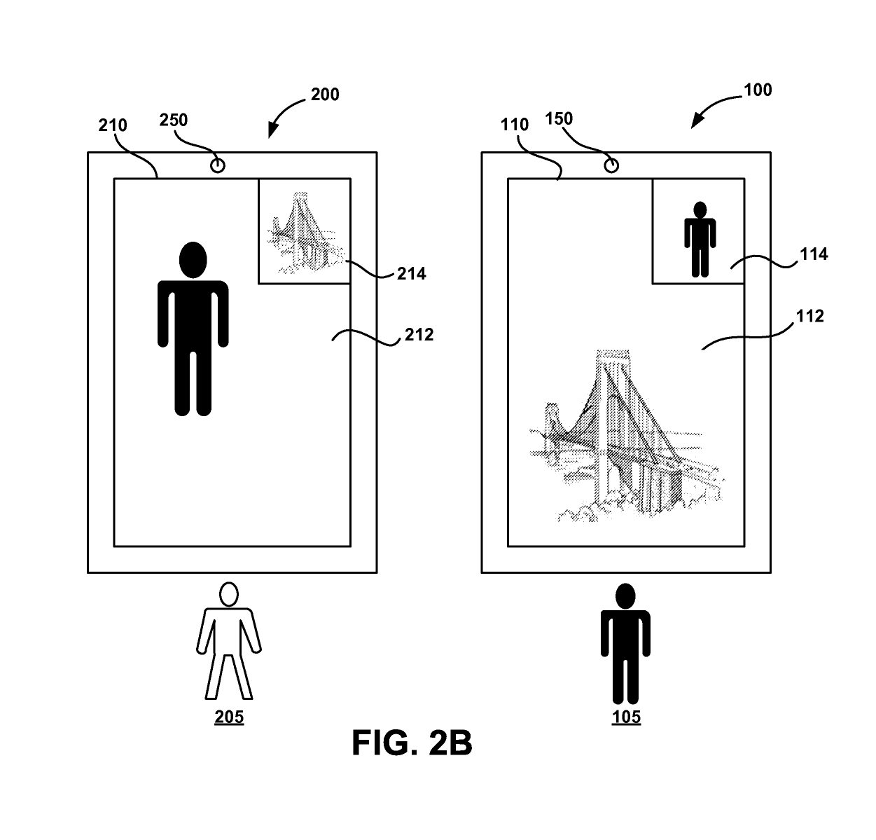

FIGS. 1A, 1B, 2A, and 2B illustrate examples of devices for integrating selected video frames into a social feed, in accordance with embodiments.

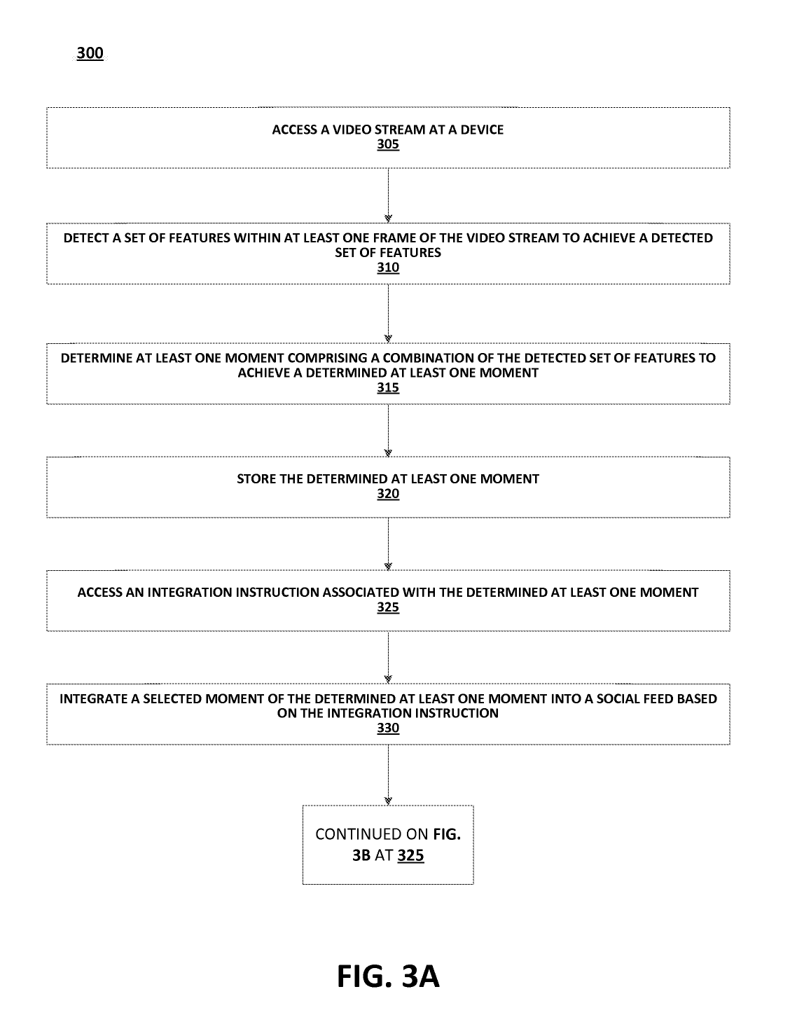

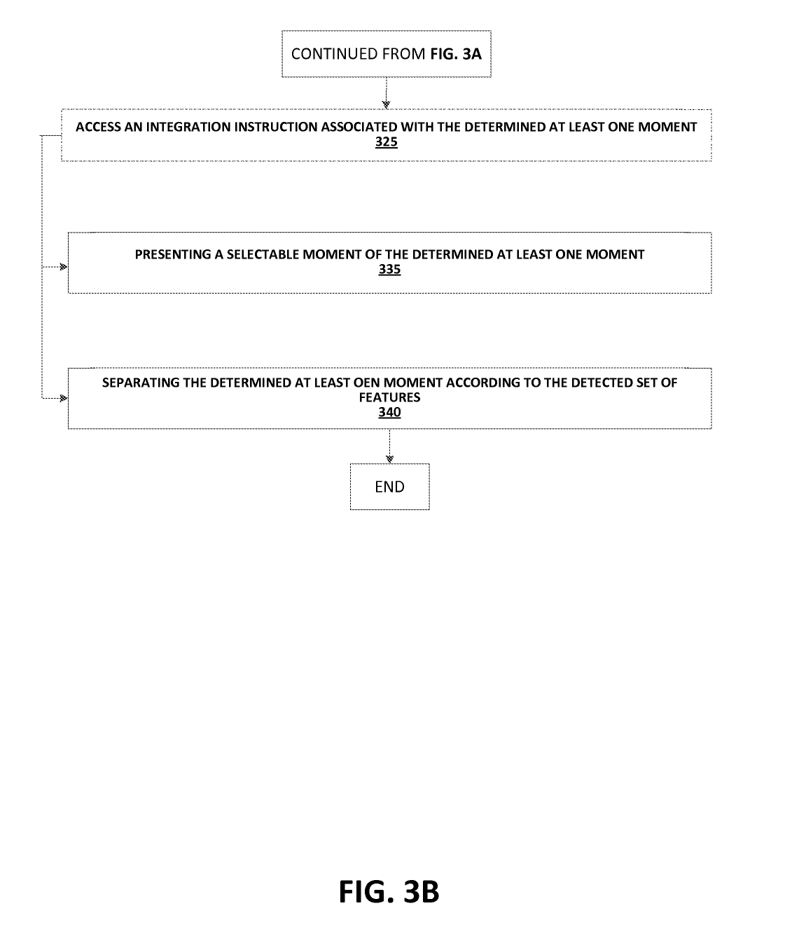

FIGS. 3A and 3B are a flow diagram of a method for integrating selected video frames into a social feed, in accordance with embodiments.

The drawings referred to in this description should be understood as not being drawn to scale except if specifically noted.

### DESCRIPTION OF EMBODIMENTS

Reference will now be made in detail to various embodiments, examples of which are illustrated in the accompanying drawings. While the subject matter will be described in conjunction with these embodiments, it will be understood that they are not intended to limit the subject matter to these embodiments. On the contrary, the subject matter described herein is intended to cover alternatives, modifications and equivalents, which may be included within the spirit and scope. Furthermore, in the following description, numerous specific details are set forth in order to provide a thorough understanding of the subject matter. However, some embodiments may be practiced without these specific details. In other instances, well-known structures and components have not been described in detail as not to unnecessarily obscure aspects of the subject matter.

Some portions of the description of embodiments which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of an electrical or magnetic signal capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present discussions terms such as “detecting”, “determining”, “accessing”, “integrating”, “separating”, “storing”, or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

As will be described below, embodiments enable a user of a first device (e.g., mobile phone) participating in a video conversation with a user of a second device (e.g., mobile phone) to capture video moments from a video stream based on certain types of heuristics, such as certain facial features, scenery, movement patterns, audio changes, etc. The user of the first device may then store at the device and/or post the captured moments from a video stream to a social media. A “moment”, in the context of embodiments, refers to a specified length of a video (including one or more video frames) and/or audio, and/or a specified expanse of time of a portion of a video and/or audio. The “portion” may be the whole or a part less than the whole of the video and/or audio. For example, in one embodiment, the portion may be a snapshot. In another example, the portion may be a video clip. Further, the specified length is predefined (e.g., preprogrammed, such as [but not limited to]: 1 second of audio and/or 1 video frame; or 3 video frames; etc., adapting to predefined conditions [e.g., programmed to increase or decrease the specified time for a moment depending on preprogrammed instructions].)

In general, a video stream provides a fluid medium for exchanging information. Participants in a video conversation may want to capture moments appearing within the video stream, amongst a wide range of events. For a video to be fluid, frames need to be transmitted and displayed at about an average rate of 15 frames per second. For example, in a 10 minute video conference call, the number of frames that are displayed is approximately 9000 frames. In order for a person to scan through these 9000 images and determine the best images (within the frames) the person desires to be presented to a social medium is impractical, if not impossible. Additionally, capturing any random frame (i.e., moment) within the video stream does not provide a significant benefit to the user because there is not a guarantee that the exact moment that the user desires to be preserved will be captured.

In an example of an embodiment, Person A is sitting at his living room at his home and is participating in a teleconference video call with Grandma. Person A's three year old daughter begins playing a drum on the living room floor. Person A points the video camera of his mobile phone towards his daughter so that Grandma can see her granddaughter smiling and playing the drums. Embodiments provide for capturing a video frame of the teleconference call according to preprogrammed instructions regarding a particular set of features. For example, embodiments may be preprogrammed to detect a significant change in sound and then capture the video frame coincident with that sound change. Further, embodiments may be preprogrammed to detect a smile and then capture the video frame coincident with the granddaughter's smile. Or, in another embodiment, embodiments may be preprogrammed to detect both of the following occurring simultaneously: a significant change in sound; and a smile. In this instance, embodiments captured video frames of the granddaughter playing the drums. In one embodiment, the user selects one or more of these video frames for integration within a particular social feed. However, in another embodiment, one or more video frames of the captured video frames are automatically selected and then automatically integrated into a predetermined social feed.

Thus, embodiments provide for the detecting (based on heuristic characteristics) and the preserving of frames of video (i.e., moments) for later use, thereby allowing for the “capturing” of the moment that the user desires to be preserved (saved). Additionally, the automatic integration of these moments into social feeds (i.e., aggregated, shared streams of information about individuals and communities) provides a medium by which special moments can be shared automatically and without a user's guidance. Embodiments analyze individual frames and meta information being passed with a video stream while using audio and/or other enhancements to allow for the automatic selection and presentation of recommended frames to a user. These other “enhancements” include, but are not limited to, the following: facial detection; scene detection; audio detection; and motion detection.

The following discussion will describe the structure and components of the system.

System for Integrating a Selected Video Frame into a Social Feed.

FIGS. 1A and 1B depict embodiments of device 100. Device 100 is configured for integrating selected video frames into a social feed. FIGS. 2A and 2B depict devices 100 and 200 participating in a video conference. In general, video conferencing allows two or more locations to interact via multi-way video and audio transmissions simultaneously.

The discussion below will first describe the components of device 100. The discussion will then describe the functionality of the components of device 100 during a video conference between devices 100 and 200. Devices 100 and 200 are any communication devices (e.g., laptop, desktop, smartphones, tablets, TV, etc.) capable of participating in a video conference. In various embodiments, device 100 is a hand-held mobile device, such as smart phone, personal digital assistant (PDA), and the like.

Moreover, for clarity and brevity, the discussion will focus on the components and functionality of device 100. However, device 200 operates in a similar fashion as device 100. In one embodiment, device 200 is the same as device 100 and includes the same components as device 100.

In one embodiment, device 100 is coupled with system 165. System 165 includes, according to embodiments: a video stream accessor 161; a feature detector 162; and a moment determiner 164. In various embodiments, system 165 optionally includes: an integration instruction accessor 166; and an integrator 168. In various embodiments, device 100 optionally includes any of the following components: a display 110; a transmitter 140; a video camera 150; a microphone 152; a speaker 154; an instruction store 125; and a global positioning system 160.

In various embodiments, the system 165 further optionally includes any of the following components: a moment presenter 189; a moment separator 185; and a moment storer 186. The integration instruction accessor 166, in various embodiments, optionally includes any of the following: a moment selection accessor 191; and a preprogrammed moment accessor 192.

The display 110 is configured for displaying video captured at device 200. In another embodiment, display 110 is further configured for displaying video captured at device 100.

The transmitter 140 is for transmitting data (e.g., control code).

The video camera 150 captures video at device 100. The microphone 152 captures audio at device 100. The speaker 154 generates an audible signal at device 100.

The global positioning system 160 determines a location of a device 100. The instruction store 125, in one embodiment, stores at least the determined at least one moment 177, and the integration instruction(s) 176 (the user selected moment(s) 194, and the preprogrammed moment selection(s) 188).

Referring now to FIGS. 2A and 2B, devices 100 and 200 are participating in a video conference with one another, in accordance with an embodiment. In various embodiments, more than two devices (including devices 100 and 200) participate in a video conference with each another.

During the video conference, the video camera 250 captures video at device 200. For example, the video camera 250 captures video of the user 205 of the device 200.

The video camera 150 captures video at the device 100. For example, the video camera 150 captures a video of the user 105. It should be appreciated that video cameras 150 and 250 can capture any objects that are within the respective viewing ranges of the cameras 150 and 250. (See discussion below with reference to FIG. 2B.)

The microphone 152 captures audio signals corresponding to the captured video signal at the device 100. Similarly, a microphone of the device 200 captures audio signals corresponding to the captured video signal at device 200.

In one embodiment, the video captured at the device 200 is transmitted to and displayed on the display 110 of the device 100. For example, a video of the user 205 is displayed on a first view 112 of the display 110. Moreover, the video of the user 205 is displayed on a second view 214 of the display 210.

The video captured at the device 100 is transmitted to and displayed on the display 210 of the device 200. For example, a video of the user 105 is displayed on the first view 212 of the display 210. Moreover, the video of the user 105 is displayed on a second view 114 of the display 110.

In one embodiment, the audio signals captured at devices 100 and 200 are incorporated into the captured video. In another embodiment, the audio signals are transmitted separate from the transmitted video.

As depicted, the first view 112 is the primary view displayed on the display 110 and the second view 114 is the smaller secondary view displayed on the display 110. In various embodiments, the size of both the first view 112 and the second view 114 are adjustable. For example, the second view 114 can be enlarged to be the primary view and the first view 112 can be diminished in size to be the secondary view (second view 114). Moreover, either the first view 112 or the second view 114 can be closed or fully diminished such that it is not viewable.

With reference now to FIG. 2B, the user 205 of the device 200 is capturing the image of a bridge 260 (instead of capturing an image of himself/herself 205), which is within the viewing range of the video camera 250. The image of the bridge is depicted at the second view 214 of the device 200, and at a first view 112 of the device 100.

With reference again to FIG. 1A, the video stream accessor 161 accesses a video stream 172 at a device, such as device 100. The feature detector 162 detects a set of features 174 in the video stream 172. With reference now to FIG. 2B, in various embodiments, the detectable set of features 174 optionally includes any of the following: a facial feature 179; a scene feature 180; an audio feature 181; and a motion feature 184. In various embodiments, the detectable audio features 181 optionally include any of the following: a moment of excitement 182; and a change in the amplitude of a sound wave 183.

The facial feature 179 is detected using techniques commonly known in the art of computer technology for detecting facial features. In one embodiment, the system 165 is preprogrammed to detect a certain combination of facial features. This combination of facial features depicts a certain desired expression. For example, a certain combination of facial features may detect what would be considered to be a pleasant expression on a face of the person being videoed. In another example, a certain combination of facial features may detect a person experiencing a sneeze attack.

With reference to the scene feature 180, the system 165 is preprogrammed to recognize certain parameters relating to a scene, such as, but not limited to, trees and lakes. The system 165 then preserves these recognized scenes. For example, a user 105 may be sitting by a lake while having a video conference on a mobile device (device 100), while the sun is setting behind the user. Since the system 165 is preprogrammed to detect a scene feature 180, the system 165 detects and captures the video frame in the video stream that depicts the sunset. Other scenes may be, but are not limited to, the following: trees, mountains, lakes, rivers, and city life.

With reference to the audio feature 181, the system 165 is preprogrammed to recognize certain types of audio, such as, but not limited to the following: a moment of excitement 182; and a change in amplitude of a sound wave 183. In various embodiments, the moment of excitement 182 may be a squeal of delight, a scene in which everyone is shouting, etc. In other embodiments, the change in amplitude of a sound wave 183 may be that of someone shouting, a horn blowing, a buzzer sounding, a sporting event in which a crowd begins cheering, etc. It should be appreciated that the system 165 may be preprogrammed to detect and preserve a particular combination of the set of features 178. For example and as described above, in a scene in which everyone is shouting, an audio feature 181 (a moment of excitement 182 and a change in the amplitude of the sound wave 183) and a facial feature 179 may be used to detect the moment that is desired to be captured and preserved by the user of device 100 and/or the user of the device with which device 100 is communicating.

In another example, the system 165 may be preprogrammed to detect and preserve the frames (moments within a video stream) in which a group of people are smiling (detecting a facial feature 179) and standing in the foreground of a forest (detecting a scene feature 180).

The moment determiner 164 determines at least one moment of the video stream (a frame) that is desired to be preserved either by the user or is preprogrammed to be preserved. This at least one moment 177 includes a combination of a detected set of features 178. As described above, this combination of a detected set of features 178 may include one or more of the features of the detected set of features 174 (e.g., smiling [facial feature] with a forest [scene feature] in the video background). Once the system 165 captures the moment, that moment is considered to be determined. As described herein, the “at least one moment” refers to a specified length of a video (including one or more video frames) and/or audio, and/or a specified expanse of time of a portion of a video and/or audio. For example, in one embodiment, but not limited to being such, the portion may be a snapshot or a video clip. It should be noted that the detected combination of the set of features 178 is preprogrammed. For example, the system 165 may be preprogrammed to include an exciting moment, including facial features 179 and audio features 181 that are symptomatic of an exciting moment. However, in another embodiment, the user of the device having the system 165 thereon may choose to start recording a video conversation. The device will store the video conversation and any portion thereof, at the device 100. If and when the user requests from the device 100 to revisit the video conversation (or any portion thereof), the video stream accessor 161 accesses the video stream at the device 100. Subsequently, a set of features 174 is detected, and then at least one moment is determined (as described herein). The user may then choose to provide “integration instructions” (as will be explained below) to the system 165.

The integration instruction accessor 166 accesses an integration instruction 176 associated with the at least one moment 177 that is determined. The integration instruction 176 instructs the system 165 as to what moments (video frames) of the video stream are desired to be preserved. In one embodiment, the user of the device (e.g., user of device 100) selects a moment from a set of selectable moments to be integrated into the social feed. The system 165 uses preprogrammed instructions to detect the at least one moment 177, via a combination of detected features. The system 165 displays these selectable moment(s) 187 to the user of the device 100 on the display 110. In one embodiment, the user of the device 100 then selects the moment that the user wishes to be integrated into the social feed 170. By the term integrated, it is meant that the subject matter (e.g., video frame) that is integrated is uploaded to the social feed 170 for display at the social feed 170 for an intended recipient. In another embodiment, the determined at least one moment 177 that is to be preserved and integrated into the social feed 170 is preprogrammed, and does not require the user's interaction in selecting a moment from a set of selectable moments 187.

Thus, in one embodiment, the integration instruction accessor 166 optionally includes: a moment selection accessor 191; and a preprogrammed moment accessor 192. The moment selection accessor 191 accesses the user selected moment 194 (having been selected by the user of the device 100 from the selectable moment(s) 187), wherein the user selected moment 194 is selected to be integrated into the social feed 170. Further, the preprogrammed moment accessor 192 accesses a preprogrammed moment selection 188 of the determined at least one moment 177 to be integrated into the social feed 170.

The integrator 168 integrates the user selected moment 194 of the selectable moment(s) 187 into the social feed 170 based on the integration instruction 176. In another embodiment, the integrator 168 integrates the preprogrammed moment selection 188 into the social feed 170 based on the integration instruction 176.

The moment presenter 189 presents a selectable moment(s) 187 of the determined at least one moment 177 to the user via the display 110, in one embodiment. The user then may select which moment of the determined at least one moment 177 that the user desires to be integrated into the social feed 170.

The moment separator 185 separates the determined at least one moment 177 according to the detected set of features. For example, all of the moments that are detected that involve scenes with lakes may be separated into one file, while all of the moments that are detected that involve scenes with mountains may be separated into a file separate from the file including the lake scenes. These files may then be presented to the user 105 by the moment presenter 189 for the user's 105. It should be appreciated that the determined at least one moment 177 may be organized and divided in various ways, and the example given above involving lakes and mountains is just an example, and is not intended to be limiting.

The moment storer 186 stores the determined at least one moment 177. In one embodiment, the determined at least one moment 177 is stored at a memory at the system 165. In another embodiment, the determined at least one moment 177 is stored at a memory coupled with the device 100.

FIGS. 3A and 3B depict a flow chart of method 300 for integrating selected video frames into a social feed. In various embodiments, method 300 is carried out by processors and electrical components under the control of computer readable and computer executable instructions. The computer readable and computer executable instructions reside, for example, in a data storage medium such as computer usable volatile and non-volatile memory. However, the computer readable and computer executable instructions may reside in any type of computer readable storage medium. In some embodiments, method 300 is performed by devices 100 and/or device 200, and more particularly, by system 165, as described in FIGS. 1A-2B.

Operation for Integration of Selected Video Frames into a Social Feed

With reference now to FIGS. 1-3B, at operation 305 of method 300, in one embodiment and as described herein, a video stream 172 is accessed.

At operation 310, in one embodiment and as discussed herein, the set of features 174 within a frame of the video stream 172 is detected. At operation 315, at least one moment is determined. The determined at least one moment 177 includes a combination of the detected set of features 178. At operation 320, in one embodiment and as described herein, the determined at least one moment 177 is stored.

At operation 325, in one embodiment and as described herein, the integration instruction 176 associated with the determined at least one moment 177 is accessed. In one embodiment and as described herein, the integration instruction 176 includes the user selected moment 194, wherein the user selected moment 194 is selected to be integrated into the social feed 170. In another embodiment and as described herein, the integration instruction 176 includes a preprogrammed moment selection 188 of the determined at least one moment 177.

At operation 330, in one embodiment and as described herein, a selected moment 193 of the determined at least one moment 177 is integrated into the social feed 170 based on the integration instruction 176. Of note, the selected moment 193 may be a user selected moment 194 or a preprogrammed moment selection 188.

At operation 335, in one embodiment and as described herein, a selectable moment 187 of the determined at least one moment 177 is presented. At operation 340, in one embodiment and as described herein, the determined at least one moment 177 is separated according to the set of features 174 that are detected.

Thus, an embodiment enables the integration of selected video frames into a social feed.

All statements herein reciting principles, aspects, and embodiments of the technology as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present technology, therefore, is not intended to be limited to the embodiments shown and described herein. Rather, the scope and spirit of present technology is embodied by the appended claims.

1. A non-transitory computer readable storage medium having stored thereon, computer-executable instructions that, when executed by a computer, cause said computer to perform a method for integrating selected video frames into a social feed, wherein said method comprises:
accessing a video stream at a device;
detecting a set of features within at least one frame of said video stream to achieve a detected set of features; and
determining at least one moment comprising a combination of said detected set of features to achieve a determined at least one moment.

2. The non-transitory computer readable storage medium of claim 1, further comprising:
storing said determined at least one moment.

3. The non-transitory computer readable storage medium of claim 1, further comprising:
accessing an integration instruction associated with said determined at least one moment; and
integrating a selected moment of said determined at least one moment into a social feed based on said integration instruction.

4. The non-transitory computer readable storage medium of claim 3, wherein said accessing an integration instruction associated with said determined at least one moment comprising:
accessing a preprogrammed integration instruction.

5. The non-transitory computer readable storage medium of claim 3, further comprising:
presenting a selectable moment of said determined at least one moment.

6. The non-transitory computer readable storage medium of claim 3, further comprising:
separating said determined at least one moment according to said detected set of features.

7. The non-transitory computer readable storage medium of claim 3, wherein said accessing an integration instruction associated with said determined at least one moment comprises:
accessing said selected moment, wherein said selected moment is selected to be integrated into said social feed.

8. The non-transitory computer readable storage medium of claim 3, wherein said accessing an integration instruction associated with said determined at least one moment comprises:
accessing a preprogrammed set of moment selections of said determined at least one moment to be integrated into said social feed.

9. The non-transitory computer readable storage medium of claim 3, wherein said accessing an integration instruction associated with said determined at least one moment comprising:
accessing a current integration instruction.

10. A device for integrating selected video frames into a social feed, wherein said device comprises:
a video stream accessor that accesses a video stream at a device;
a feature detector that detects a set of features in said video stream; and
a moment determiner that determines at least one moment comprising a combination of detected set of features to achieve a determined at least one moment.

11. The device of claim 10, further comprising:
a moment storer that stores said determined at least one moment.

12. The device of claim 10, further comprising:
an integration instruction accessor that accesses an integration instruction associated with said determined at least one moment; and
an integrator that integrates a selected moment of said determined at least one moment into a social feed based on said integration instruction.

13. The device of claim 12, wherein said integration instruction accessor comprises:
a moment selection accessor that accesses said selected moment, wherein said selected moment is selected to be integrated into said social feed.

14. The device of claim 12, wherein said integration instruction accessor comprises:
a preprogrammed moment accessor that accesses a preprogrammed moment selection of said determined at least one moment to be integrated into said social feed.

15. The device of claim 10, further comprising:
a moment presenter that presents a selectable moment of said determined at least one moment.

16. The device of claim 10, further comprising:
a moment separator that separates said determined at least one moment according to said detected set of features.

17. The device of claim 10, wherein said detected set of features comprises:
a facial feature.

18. The device of claim 17, wherein said facial feature comprises:
a pleasant expression.

19. The device of claim 10, wherein said detected set of features comprises:
a feature associated with a scenery.

20. A device of claim 10, wherein said detected set of features comprises:
an audio feature.

21. The device of claim 20, wherein said audio feature comprises:
an audio feature exhibiting a moment of excitement.

22. The device of claim 20, wherein said audio feature comprises:
a change in an amplitude of a sound wave, wherein said change meets a amplitude threshold.

23. The device of claim 10, wherein said detected set of features comprises:
a motion.

24. The device of claim 10, wherein said device comprises:
a mobile phone.
